(19) United States
(12) Patent Application Publication
(10) Pub. No.: US 2025/0184790 A1
(43) Pub. Date: Jun. 5, 2025

(54) L1 REPORTING ENHANCEMENT IN MTRP FOR PREDICTIVE BEAM MANAGEMENT

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/842,031

(22) PCT Filed: Apr. 27, 2022
(86) PCT No.: PCT/CN2022/089485

§ 371 Date: Aug. 27, 2024

(51) Int. Cl. H04W 24/10; H04B 7/06; H04B 17/309; H04L 5/00

(52) U.S. Cl. CPC H04W 24/10; H04B 7/0626; H04B 7/06952; H04B 17/309; H04L 5/0048

(57) ABSTRACT

This disclosure provides systems, devices, apparatus, and methods, including computer programs encoded on storage media, for reporting enhancements to predictive beam management. A UE may measure at least one of an RSRP or a SINR associated with one or more secondary CMR-IDs of a CMR set. The one or more secondary CMR-IDs of the CMR set may be different CMR-IDs from a primary CMR-ID of the CMR set. The UE may report the at least one of the RSRP or the SINR associated with the one or more secondary CMR-IDs based on one or more CMR-ID selection protocols for the one or more secondary CMR-IDs.

### TECHNICAL FIELD

The present disclosure relates generally to communication systems, and more particularly, to reporting enhancements for predictive beam management.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may measure at least one of a reference signal received power (RSRP) or a signal-to-interference-plus-noise ratio (SINR) associated with one or more secondary channel measurement resource (CMR) identifiers (IDs) (CMR-IDs) of a CMR set, the one or more secondary CMR-IDs of the CMR set being different CMR-IDs from a primary CMR-ID of the CMR set; and report the at least one of the RSRP or the SINR associated with the one or more secondary CMR-IDs based on one or more CMR-ID selection protocols for the one or more secondary CMR-IDs.

In another aspect of the disclosure, a method, a computer-readable medium, and an apparatus are provided. The apparatus may transmit a plurality of reference signals on a CMR set including a primary CMR-ID and one or more secondary CMR-IDs that are different from the primary CMR-ID, the one or more secondary CMR-IDs associated with at least one of an RSRP or a SINR; and receive a report of the at least one of the RSRP or the SINR associated with the one or more secondary CMR-IDs of the CMR set based on one or more CMR-ID selection protocols for the one or more secondary CMR-IDs.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a base station and user equipment (UE) in an access network.

FIG. 4 is a diagram that illustrates a beam management procedure.

FIG. 5 is a diagram that illustrates a model training and model inference procedure based on data collection.

FIG. 6 illustrates a diagram and associated table indicative of channel state information (CSI) reporting based on multiple transmission and reception points (mTRP).

FIG. 7 is a diagram that illustrates channel measurement resource (CMR) set-specific adjacency procedures.

FIG. 8 is a diagram that illustrates reporting bits for CMR set-specific adjacency procedures.

FIG. 9 is a call flow diagram illustrating communications between a UE and a network entity.

FIG. 10 is a flowchart of a method of wireless communication at a UE.

FIG. 11 is a flowchart of a method of wireless communication at a UE.

FIG. 12 is a flowchart of a method of wireless communication at a network entity.

FIG. 13 is a flowchart of a method of wireless communication at a network entity.

FIG. 14 is a diagram illustrating an example of a hardware implementation for an example apparatus and/or network entity.

FIG. 15 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission and reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

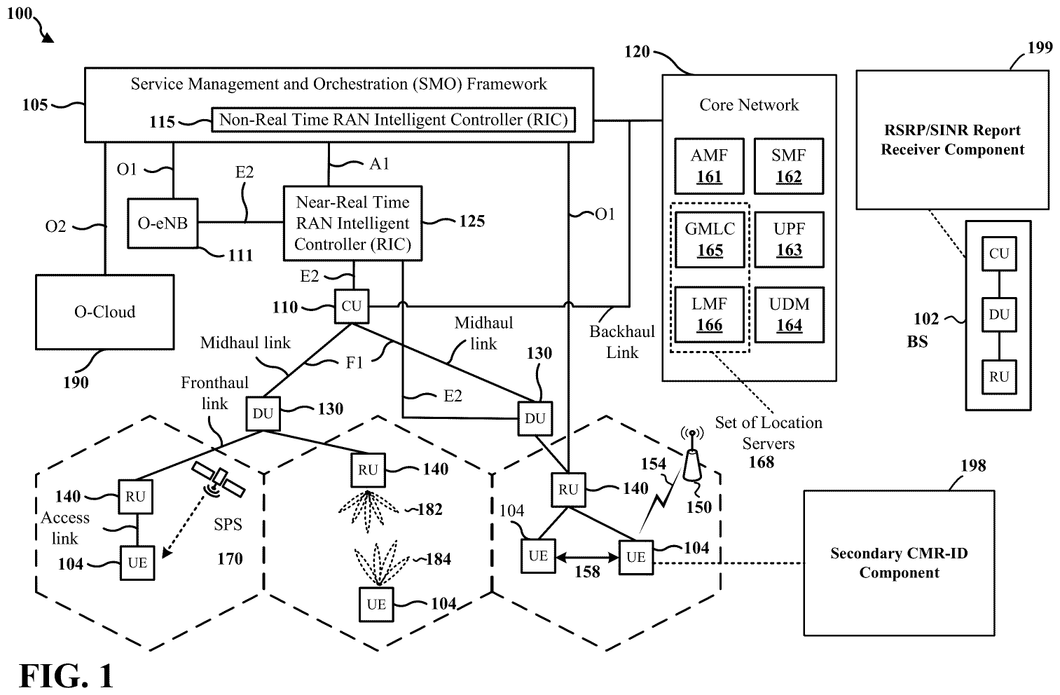

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective user equipments (UEs) 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUS 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FRI is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a secondary channel measurement resource (CMR) identifier (ID) (CMR-ID) component 198 configured to measure at least one of a reference signal received power (RSRP) or a signal-to-interference-plus-noise ratio (SINR) associated with one or more secondary CMR-IDs of a CMR set, the one or more secondary CMR-IDs of the CMR set being different CMR-IDs from a primary CMR-ID of the CMR set; and report the at least one of the RSRP or the SINR associated with the one or more secondary CMR-IDs based on one or more CMR-ID selection protocols for the one or more secondary CMR-IDs. In certain aspects, the base station 102 or a network entity of the base station 102 may include a RSRP/SINR report receiver component 199 configured to transmit a plurality of reference signals on a CMR set including a primary CMR-ID and one or more secondary CMR-IDs that are different from the primary CMR-ID, the one or more secondary CMR-IDs associated with at least one of an RSRP or a SINR; and receive a report of the at least one of the RSRP or the SINR associated with the one or more secondary CMR-IDs of the CMR set based on one or more CMR-ID selection protocols for the one or more secondary CMR-IDs. Although the following description may be focused on 5G NR, the concepts described herein may be applicable to other similar areas, such as LTE, LTE-A, CDMA, GSM, and other wireless technologies.

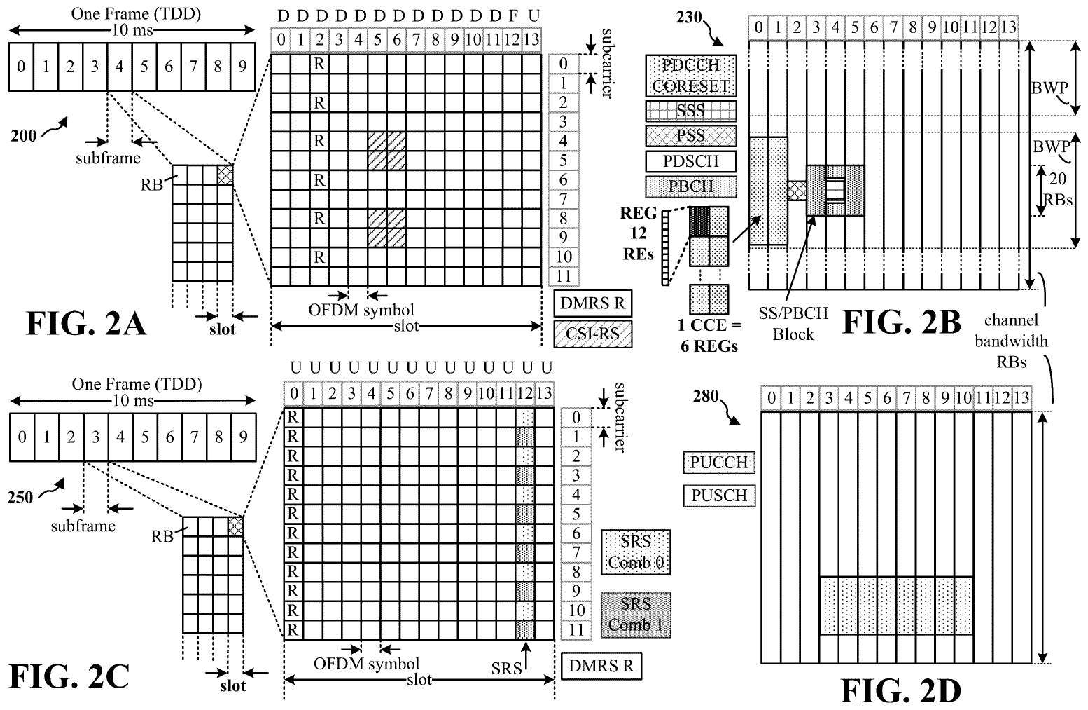

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

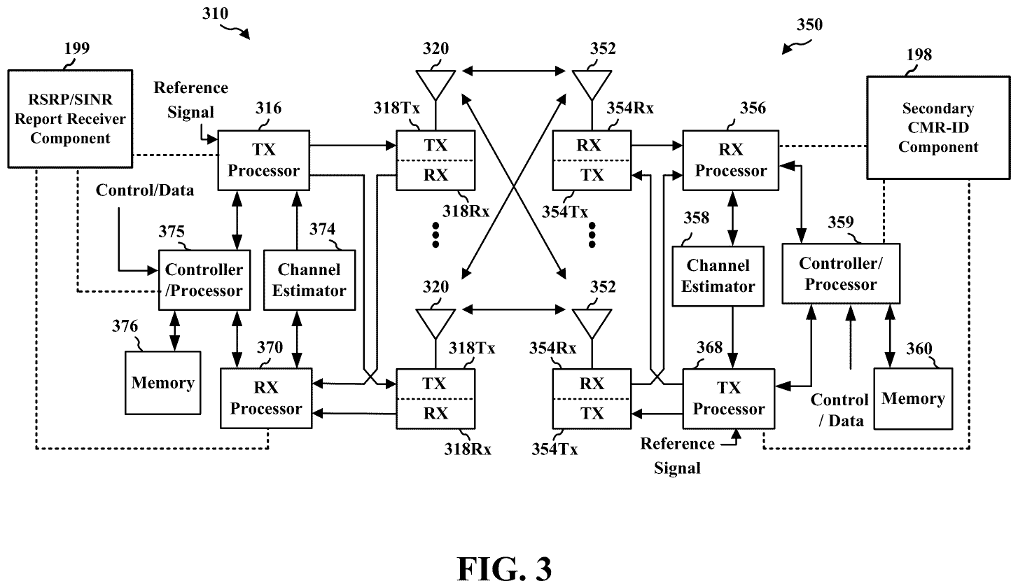

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, onto physical channels, mapping modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer I functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the secondary CMR-ID component 198 of FIG. 1.

At least one of the TX processor 316, the RX processor 370, and the controller/processor 375 may be configured to perform aspects in connection with the RSRP/SINR report receiver component 199 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and ultra-reliable low latency communication (URLLC) may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

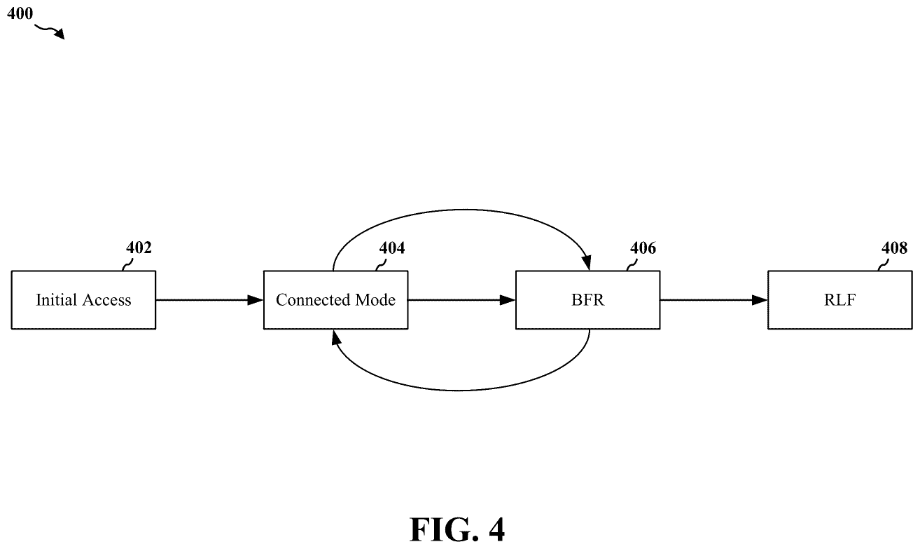

FIG. 4 is a diagram 400 that illustrates a beam management procedure. The beam management procedure may be initiated via an initial access procedure 402. In examples, the initial access procedure 402 may include an association between an SSB and a random access channel (RACH), an SSB beam sweeping procedure, a CSI-RS beam sweeping procedure, etc. Beam sweeping refers to a technique for transmitting a number of beams in a predefined direction at regular intervals. A beam pair may be selected between a base station and a UE based on an SSB beam sweeping procedure. Hierarchical beam refinement techniques between the base station and the UE may be performed based on a CSI-RS beam sweeping procedure. Beams used for the initial access procedure 402, such as layer 1 (L1) beams, may have an increased beam width.

The UE and the base station may enter a connected mode 404 after performing the initial access procedure 402. For example, the UE and the base station may be RRC connected. An L1 report indicative of the beams associated with the UE and the base station may be used for beam refinement in the connected mode 404. If the UE transitions from the connected mode 404 to an idle mode or an inactive mode (e.g., RRC idle or RRC inactive), the UE may attempt to perform a beam failure recovery (BFR) procedure 406 with the base station. If the BFR procedure 406 is successful, the UE may transition back to the connected mode 404. Otherwise, the UE may determine that a radio link failure (RLF) 408 has occurred, such that the UE may have to perform another RACH procedure with the base station in order to return to the connected mode 404.

A CSI report may be indicative of an SSB resource indicator (SSBRI) and/or a CSI-RS resource indicator (CRI) as well as an L1-RSRP report and/or an L1-SINR report. While L1-RSRPs/SINRs may be discussed herein for purposes of example, the RSRPs/SINRs may also correspond to layer 3 (L3)-RSRPs/SINRs. The UE may be configured based on a ReportQuantity=ssb-Index-RSRP, an ssb-Index-SINR, a cri-RSRP, a cri-SINR, etc., for joint SSBRI/CRI and L1-RSRP/L1-SINR beam reporting. The UE may report a nrofReportedRS, which may be RRC configured for 2-4 reference signals based on a UE capability. The UE may also report different SSBRI or different CRI for each CSI-ReportConfig.

For L1-RSRP reporting, 7 bits may be used to report the RSRP (e.g., within a range of [−140, −44] dB with a 1 dB step size) for a strongest beam based on an SSBRI/CRI. For remaining SSBRIs/CRIs, 4 bits may be used to report different RSRPs (e.g., within a range of [0, −30] dB with a 2 dB step size) and a reference to a strongest L1-RSRP of the SSBRIs/CRIs. The strongest L1-RSRP of the SSBRIs/CRIs may be associated with invalid code points for mapping the reported 7 bits or 4 bits based on the measured RSRP values. Beam IDs may be explicitly reported based on a number of total SSBs or CSI-RS within a resource set.

For L1-SINR reporting, 7 bits may be used to report the SINR (e.g., within a range of [−23, 40] dB with a 0.5 dB step size) for the strongest SSBRI/CRI. For remaining SSBRIs/CRIs, 4 bits may be used to report different SINR (e.g., within a range of [0, −15] dB with a 1 dB step size) and a reference to a strongest L1-SINR of the SSBRIs/CRIs. The SSBRI/CRI associated with the strongest L1-SINR and the remaining SSBRIs/CRIs may have no invalid code points. In an example, SINR_0 may be indicative of SINR<−23 dB for the strongest SSBRI/CRI, while DIFFSINR_15 may be indicative of a ΔSINR≤−15 dB. A mapping may be performed between the reported 7-bit or 4-bit code points and the measured SINR.

Artificial intelligence (AI)/machine learning (ML) techniques may be used for air-interface procedures based on a performance, complexity, overhead, accuracy, etc., at the UE. For example, a channel state information (CSI) feedback enhancement may include an overhead reduction, improved accuracy, and/or improved prediction. Beam management procedures, such as a beam prediction in time domain and/or spatial domain for overhead and latency reduction, may be improved based on a beam selection accuracy. Positioning accuracy enhancements may also be provided for different conditions, such as non-line of sight (NLOS) conditions. AI/ML techniques may support collaboration protocols between the base station and the UE.

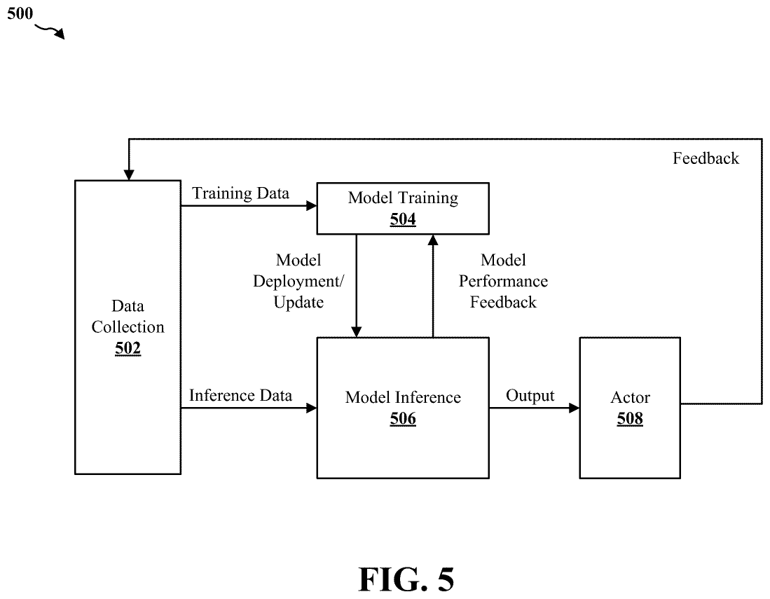

FIG. 5 is a diagram 500 that illustrates a model training and model inference procedure based on data collection 502. Data collection 502 may be used to provide input data for model training 504 and model inference 506. In examples, AI/ML-specific data preparation procedures, such as data pre-processing and cleaning, data formatting, data transformation, etc., may be performed separately from the data collection 502. Example input data may include measurements from different UEs and/or measurements from different network entities, feedback from an actor 508, an output from an AI/ML model, etc.

Model training 504 may be based on training data received as input from the collected data. That is, training data from the data collection 502 may be used for an AI/ML model training function. Inference data may be similarly received as input from the collected data for model inference 506 (e.g., AI/ML model inference). The model inference 506 may correspond to a function that performs the model training 504, validation, and/or testing, which may be indicative of model performance metrics associated with model operations. The model training 504 may also perform data preparation (e.g., data pre-processing and cleaning, data formatting, and/or data transformation) based on the training data received from data collection 502.

A model deployment/update may be provided for model inference 506 based on the model training 504. The model deployment/update may be used to initially deploy a trained, validated, and/or tested AI/ML model for the model inference 506 and/or to provide an updated model for the model inference 506. Model performance feedback may or may not be provided for subsequent model training 504 based on the model inference 506. The model inference 506 may likewise perform data preparation (e.g., data pre-processing and cleaning, data formatting, and/or data transformation) based on the inference data received from data collection 502. The AI/ML model inference output of the AI/ML model may be based on the model inference 506 and may be use case specific.

The model inference 506 may generate an AI/ML model inference output (e.g., prediction, decision, etc.), which may be received by an actor 508. The actor 508 may be any entity or function that triggers or performs one or more corresponding actions based on the output of the model inference 506. The actor 508 may trigger actions of the actor 508 or actions of other entities. Feedback from the actor 508 may be provided for data collection 502, e.g., if model inference procedures indicate that the feedback may be used to improve the AI/ML model trained via the model training 504. Feedback from the actor 508 or other network entities based on the data collection 502 may be utilized for the model inference 506 to generate model performance feedback.

L1 reporting enhancements may be based on multiple TRP (mTRP) configurations. A single CSI report may be indicative of N beam pairs/groups and M beams per beam pair/group, where M>1. Different beams within a beam pair/group may be received simultaneously. For example, 2 channel measurement resource (CMR) sets or subsets may be received per periodic/semi-persistent CMR. Each reported beam pair in a single CSI report may include M=2 SSBRI/CRI values, where each SSBRI/CRI may point to a CMR of a different CMR set or subset. The bit size of each SSBRI/CRI may be determined based on a number of SSB/CSI-RS resources in the associated CMR set. A maximum number of beam groups in a single CSI-report may correspond to a UE capability and may be of values from Nₘₐₓ={1, 2, 3, 4}. The number of beam pairs/groups N reported based on a single CSI report may be RRC configured.

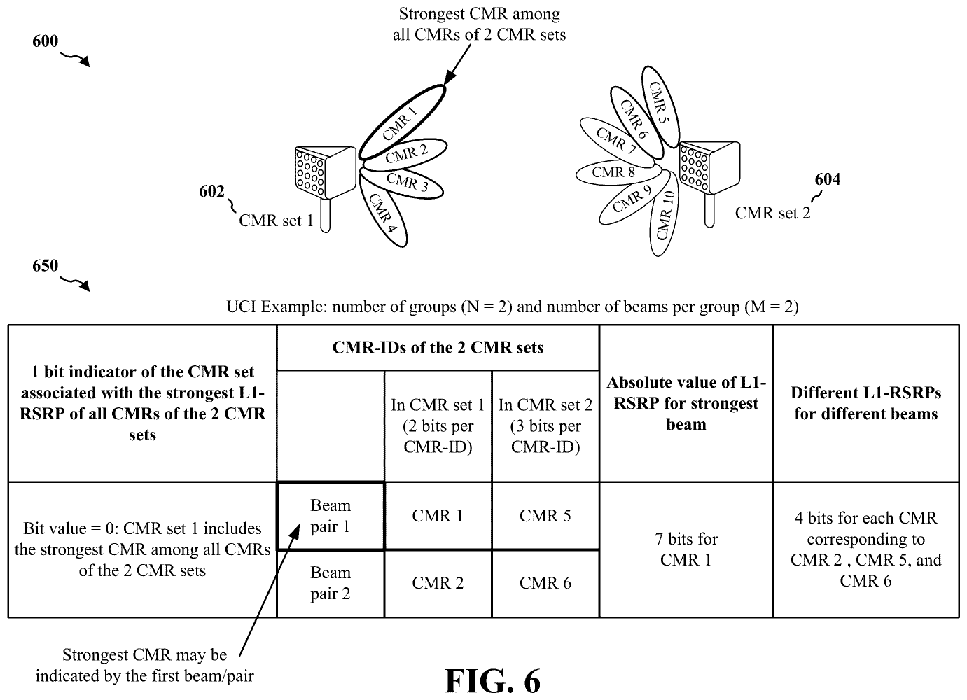

FIG. 6 illustrates a diagram 600 and a table 650 indicative of CSI reporting based on mTRP. For example, a first TRP may be associated with CMR set 1 602 including CMRs 1-4 and a second TRP may be associated with CMR set 2 604 including CMRs 5-10. An RRC parameter, such as CSI-AssociatedReportConfigInfo, may be configured based on two CMR sets (e.g., CMR set 1 602 and CMR set 2 604) for periodic and semi-persistent resources. The two CMR sets may or may not be associated with different TRPs. That is, CMR set 1 602 and CMR set 2 604 may be associated with a same TRP in some examples.

The number of beams per group M may or may not be greater than 2 beams per group for beam reporting based on periodic and semi-persistent resources. For aperiodic resources, each CMR set of the two CMR sets (e.g., CMR set 1 602 and CMR set 2 604) may be configured based on corresponding quasi co-location (QCL) information. The UE may select a first CMR (e.g., CMR 1) associated with the first TRP based on measured RSRPs from the different TRPs. CMR 1 may be selected by the UE based on CMR 1 being the strongest CMR among all CMRs of the two CMR sets. A second CMR (e.g., CMR 5) may be paired with the first CMR (e.g., CMR 1), so that different beams within the pair may be received simultaneously by mTRPs. That is, the UE may select the first CMR from the first TRP/base station and the second CMR from the second TRP/base station, which may be paired and received simultaneously by the UE.

The table 650 illustrates a UCI example where the number of groups is N=2 and the number of beams per group is M=2. A 1-bit indicator of the CMR set may be associated with the strongest L1-RSRP of all the CMRs (e.g., CMRs 1-10) of the 2 CMR sets (e.g., CMR set 1 602 and CMR set 2 604). For example, a bit value of 0 may indicate that CMR set 1 602 includes the strongest CMR among all CMRs of the 2 CMR sets. A bit value of 1 may indicate that CMR set 2 604 includes the strongest CMR among all CMRs of the 2 CMR sets. That is, the 1-bit indicator may indicate the CMR set with the highest RSRP value (e.g., 0 may indicate a first SSBRI/CRI from CMR set 1 602 and I may indicate the first SSBRI/CRI from CMR set 2 604). In the table 650, the strongest beam/CMR is indicated as being in CMR set 1 602 based on the bit value being equal to 0.

Each of the CMRs 1-10 of the 2 CMR sets may be associated with a CMR-ID. The strongest CMR (e.g., CMR 1) may be included in the first beam pair/group associated with RSRPs reported from the different CMR sets. For example, beam pair 1 may include CMR 1 and CMR 5, where CMR 1 corresponds to the strongest CMR. Including the strongest CMR in beam pair 1 may or may not be based on a predefined rule/protocol. If the strongest CMR is associated with beam pair 1 (e.g., based on the predefined rule/protocol), the indicator bit may indicate which CMR set includes CMR 1. Beam pair 2 may include next strongest CMRs associated with the RSRPs reported from the different CMR sets. For example, beam pair 2 may include CMR 2 and CMR 6. The table 650 illustrates that the CMR-IDs in CMR set 1 602 are indicated based on 2 bits per CMR-ID and the CMR-IDs in CMR set 2 604 are indicated based on 3 bits per CMR-ID.

A UCI payload may be partitioned into 7 bits and 4 bits for the first and second SSBRI/CRI in the beam groups. The strongest CMR may be reported based on 7 bits and the remaining CMRs may be reported based on 4 bits. For example, 7 bits may be used to report CMR 1, which may correspond to the strongest CMR, and 4 bits may be used to report each CMR corresponding to CMR 2, CMR 5, and CMR 6, which may correspond to the remaining CMRs of beam pair 1 and beam pair 2. The 4 bits may implicitly refer to the strongest CMR as being CMR1, for example, based on the 4 bits being associated with other/remaining CMRs. L1-RSRP reporting may include L1-RSRPs for different beams (e.g., CMR 2, CMR 5, and CMR 6) in a CSI report. An absolute value of an L1-RSRP for the strongest beam (e.g., CMR 1) may be included in the CSI report. In examples that are based on one CMR set, the indicator bit may not be included in the report to indicate the beam pairs.

After the strongest beam is indicated from the one or more CMR sets, the UE may determine neighboring beams in adjacent directions to the strongest beam, where the neighboring beams may be indexed based on CMR-IDs. However, if the UE reports too many indexes, the overhead may be high. Thus, the neighboring beams/CMRs may be explicitly or implicitly determined based on a target beam/CMR to report/identify one or more next strongest beams and associated L1-RSRPs/SINRs.

Overhead reduction techniques may be performed based on the L1-RSRPs/SINRs via an ML-based beam management procedure, such as beam blockage predictions based on RSRP fingerprints, data collection, time division RSRP, beam change predictions, etc. The adjacency of the neighboring beams to the strongest beam may be determined based on beam direction information associated with the CMRs separately configured/indicated by the base station. The adjacency of the neighboring beams to the strongest beam may also be identified based on one or more indices to one or more of the CMR-IDs, or based on explicitly configured/indicated adjacent/neighboring CMR-IDs by the base station based on a primary CMR-ID associated with the strongest beam.

The number of next strongest L1-RSRPs/SINRs associated with the different CMR sets (e.g., CMR set 1 602 and CMR set 2 604) may correspond to different TRPs and may be reported from the UE to the base stations based on mTRP configurations. A quantization technique of the L1-RSRPs/SINRs may be different for the different CMR sets based on whether a CMR set includes the strongest CMR among all the CMRs, a total number of CMRs within a CMR set, the TRP from which the UE receives DCI, etc. “Quantization” refers to techniques associated with a number of bits used to represent the L1-RSRPs/SINRs measured at the UE, such as the number of bits used for a particular L1-RSRP/SINR, a dynamic range that such bits may represent, an absolute value or a differential value that refers to another quantized/reported L1-RSRP/SINR, etc. CMR set-specific adjacent/neighboring CMR-ID determination techniques and associated L1-RSRP/SINR quantization procedures may be performed to enhance L1-RSRP reporting for mTRP configurations. Reporting techniques based on mTRP may provide an overhead reduction via ML-based beam management procedures.

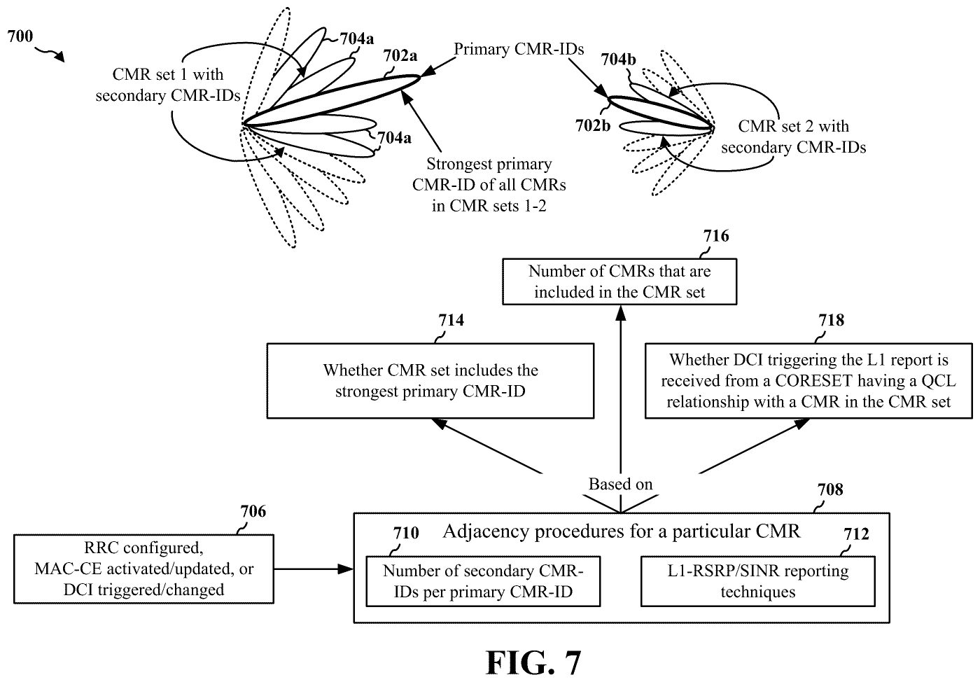

FIG. 7 is a diagram 700 that illustrates CMR set-specific adjacency procedures. For example, one or more next strongest beams/secondary beams associated with one or more secondary CMR-IDs 704a-704b to a strongest beam/primary beam associated with a primary CMR-ID 702a-702b as well as secondary L1-RSRPs/SINRs of the one or more secondary CMR-IDs 704a-704b may be reported by the UE to mTRPs. The UE may be configured/activated/triggered to periodically, semi-persistently, or aperiodically report the primary L1-RSRPs/SINRs for the strongest/primary CMR-IDs 702a-702b included in a group of multiple CMR sets. The UE may explicitly indicate which CMR set includes the strongest CMR among a number of measured CMRs. In some examples, a plurality of primary CMR-IDs may be reported as being located within a same CMR set.

The UE may report N primary CMR-ID groups, which may include M CMR-IDs per group, where the CMR-IDs within each primary CMR-ID group may be selected from respective CMR sets. The strongest primary CMR-ID 702a of all CMRs in CMR sets 1-2 may be reported within the first primary CMR-ID group. Strongest primary CMR-ID refers to a strongest beam of a plurality of beams emitted from mTRPs. The UE may report an absolute value for the L1-RSRP/SINR of the strongest primary CMR-ID 702a in addition to reporting different L1-RSRP/SINR values of other primary CMR-IDs, such as the other primary CMR-ID 702b.

Different CMR sets may be associated with different CMR set-specific adjacency procedures. For example, the neighboring/adjacent CMRs, which may be referred to as secondary CMRs, may be used to adaptively determine secondary CMR-IDs 704a-704b based on previously determined primary CMR-IDs 702a-702b and/or the associated primary L1-RSRPs/SINRs. Primary CMR-IDs refer to one or more strongest beams of one or more TRPs. Secondary CMR-IDs refer to one or more other beams of the one or more TRPs that may serve as a fallback to the one or more strongest beams of one or more TRPs. CMR set 1 may include a first set of secondary CMR-IDs 704a and CMR set 2 may include a second set of secondary CMR-IDs 704b. The UE may report the L1-RSRPs/SINRs associated with the secondary CMR-IDs 704a-704b. The periodic, semi-persistent, and aperiodic reports may be configured based on respective periodic, semi-persistent, and aperiodic CSI reporting procedures. Report procedures may refer to procedures of the physical layer, such as a higher layer confirmation indicative of techniques for reporting the CSI report. The CMR may include at least one of a CSI-RS resource or an SSB resource. The secondary CMR-IDs 704a-704b may be different from the previously determined primary CMR-IDs 702a-702b.

The CMR set-specific adjacency procedures may be predefined (e.g., standardized) or, at 706, the CMR set-specific adjacency procedures may be RRC configured, MAC-CE activated/updated, or DCI triggered/changed, for different CMR sets. At 708, the UE may determine the adjacency procedures for a particular CMR associated with the previously determined primary CMR-IDs 702a-702b and/or L1-RSRPs/SINRs within the CMR set to report the secondary CMR-IDs 704a-704b. Some CMR set-specific adjacency procedures may be based on a maximum number of CMRs to be reported for the CMR set, which may be a different number of CMRs for different CMR sets.

At 712, the CMR set-specific adjacency procedures may be based on L1-RSRP/SINR reporting techniques. For example, the secondary CMR-IDs 704a-704b and/or associated secondary L1-RSRPs/L1-SINRs may be quantized based on corresponding primary CMR-IDs 702a-702b and/or the primary L1-RSRPs/L1-SINRs associated with the primary CMR-IDs 702a-702b. Quantization techniques may also be different for different CMR sets. CMR set-specific procedures refers to procedures that may be differently configured, indicated, etc., for different CMR sets.

At 710, the CMR set-specific adjacency procedures may be based on a CMR sct-specific number of secondary CMR-IDs 704a-704b per primary CMR-ID 702a-702b. For a particular CMR set, the number of secondary CMR-IDs 704a-704b determined for each primary CMR-ID 702a-702b within the CMR set may, at 714, be based on whether the CMR set includes the strongest primary CMR 702a among the measured number of CMRs. The CMR set (e.g., CMR set 1) that includes the strongest primary CMR 702a may be of higher priority than other CMR sets (e.g., CMR set 2). However, ML inference and/or data collection for prioritization of the CMR sets may be based on an increased amount of information. For example, X secondary CMR-IDs 704a may be determined for the CMR set that includes the strongest primary CMR-ID 702a, while Y<X secondary CMR-IDs 704b may be determined for other CMR sets. Similar techniques may also be performed based on the CMR set not including the strongest primary CMR 702a among the measured number of CMRs.

The number of secondary CMR-IDs 704a-704b determined for each primary CMR-ID 702a-702b within a particular CMR set may, at 716, be further based on the number of CMRs that are included in the CMR set. For instance, a first CMR set may include a greater number of CMRs than one or more other CMR sets. In an example, X1 secondary CMR-IDs 704a may be determined for a first CMR set including N1 CMRs, while X2<X1 secondary CMR-IDs 704b may be determined for a second CMR set including N2<N1 CMRs.

If multiple CMR sets are aperiodically triggered or semi-persistently activated, or if the CSI report including the L1 report is aperiodically triggered or semi-persistently activated based on a single DCI having a CORESET that is in a QCL relationship with one source reference signal of at least Type-D QCL with one of the CMRs among the measured number of CMRs, the UE may determine a higher or lower number of secondary CMR-IDs 704a-704b for the CMR set including the CMR that is in the QCL relationship associated with the CORESET. That is, the CMR set-specific adjacency procedures may, at 718, be based on whether DCI triggering the L1 report is received from a CORESET having a QCL relationship with a CMR in the CMR set. The UE may be configured with different CORESET pools. Each CORESET pool may correspond to a particular QCL source, such that the UE may use different Rx beams to receive the CORESETs associated with the different CORESET pools. The UE may be DCI triggered with an aperiodic CSI report for L1 reporting, where the CORESET including the DCI may be in the QCL relationship with the first CMR, which may be included in the first CMR set of the multiple CMR sets. X secondary CMR-IDs 704a may be determined for the CMR set including the CMR that is in the QCL relationship associated with the CORESET, while Y<X secondary CMR-IDs 704b may be determined for other CMR sets.

The CMR set-specific adjacency procedures may be based on capabilities of the UE. For example, a maximum number of beam groups included in a single CSI report may be based on UE capabilities. Similarly, the maximum number of beam pairs may be reported based on the UE capabilities. The UE may report UE capabilities associated with the number of secondary CMR-IDs 704a-704b. The UE capabilities may be indicative of a total number of secondary CMR-IDs 704a-704b among multiple CMR sets. The UE capabilities may also be indicative of a CMR set-specific total number of secondary CMR-IDs 704a-704b. The UE capabilities may be further dependent on an adjacency identification procedure that may be executed at the UE.

The UE may report a first total number of secondary CMR-IDs 704a for the CMR set including the strongest primary CMR 702a and subsequently report a second total number of secondary CMR-IDs 704b for other CMR sets. The report of the first total number of secondary CMR-IDs 704a for the CMR set may include more than N₁ CMRs, whereas the report for the second total number of secondary CMR-IDs 704b for the CMR set may include N₂<CMRs<N₁, where the UE may report a kth total number of secondary CMR-IDs for the CMR set based on Nₖ<CMRs<Nₖ₋₁. The report of the first total number of secondary CMR-IDs 704a for the CMR set may include the CMR that is in the QCL relationship with the CORESET carrying the DCI that triggers the aperiodic CSI report. The UE may also report the second total number of secondary CMR-IDs 704b for the other CMR sets.

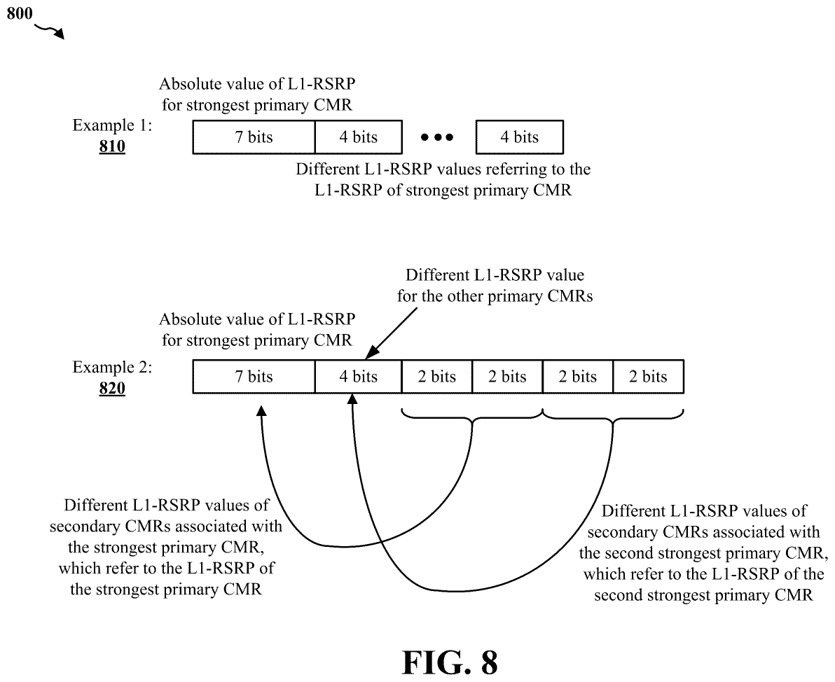

FIG. 8 is a diagram 800 that illustrates reporting bits for CMR set-specific adjacency procedures. An L1-RSRP/L1-SINR reporting technique may be based on a number of bits used to indicate a particular L1-RSRP/L1-SINR and/or a dBm/dB step size between adjacent bits that point to different CMRs. The L1-RSRPs/L1-SINRs of the secondary CMR-IDs may be reported based on different procedures.

In a first example 810, the L1-RSRP/L1-SINR of the strongest/weakest primary CMR-ID of all the measured primary CMR-IDs may be reported. For example, the UE may report an absolute value of the L1-RSRP for the strongest primary CMR based on 7 bits. Secondary beams that do not correspond to the strongest/primary beams may each be indicated based on 4 bits and may point to the strongest/primary beam. That is, different L1-RSRP values may refer to the L1-RSRP of the strongest primary CMR.

In a second example 820, the L1-RSRP/L1-SINR of the primary CMR-ID associated with the secondary CMR-IDs may be reported. The primary CMR-ID may be indicated based on a different number of bits or step size than used to indicate the secondary CMR-IDs. For example, the UE may report an absolute value of the L1-RSRP for the strongest primary CMR based on 7 bits. A different L1-RSRP value may be reported for other primary CMRs based on 4 bits. Thus, a 4-bit indication for a particular CMR set may be used to indicate a second strongest primary CMR-ID.

L1-RSRPs/L1-SINRs associated with secondary CMRs/beams may be indicated with less than 4 bits. For instance, a first set of 2 bits may be used to indicate two secondary CMR-IDs that may refer to the strongest/primary CMR-ID, and a second set of 2 bits may be used to indicate another two secondary CMR-IDs that may refer to the second strongest/primary CMR-ID. Hence, different L1-RSRP values of secondary CMRs associated with the strongest primary CMR may refer to the L1-RSRP of the strongest primary CMR, and different L1-RSRP values of secondary CMRs associated with the second strongest primary CMR may refer to the L1-RSRP of the second strongest primary CMR.

Reporting the L1-RSRPs/SINRs of the secondary CMR-IDs of the CMR set may be further based on the number of secondary CMR-IDs determined for the CMR set. A first CMR set may include N1 secondary CMR-IDs and a second CMR set may include N2<N1 secondary CMR-IDs. The first CMR set may be associated a first number of bits B1 for a particular L1-RSRP/SINR, while the second CMR set may be associated with a second number of bits B2>B1 for another L1-RSRP/SINR. The dBm/dB step size between adjacent bits that point to the first CMR set may be greater than the dBm/dB step size between adjacent bits that point to the second CMR set. The total number of bits may be different in various examples based on the number of secondary CMR-IDs being indicated.

The L1-RSRPs/L1-SINRs for the primary CMR-IDs and the secondary CMR-IDs may be indicated via a same CSI report or different CSI reports. For example, the L1-RSRPs/SINRs associated with the secondary CMR-IDs may be reported by the same CSI report that includes the primary CMR-IDs and the associated primary L1-RSRPs/L1-SINRs. The primary CMR-IDs and the primary L1-RSRPs/SINRs may be indicated via a first portion of the CSI, while the secondary CMR-IDs and the secondary L1-RSRPs/SINRs may be indicated via a second portion of the CSI. The second portion of the CSI may have a flexible payload for which the priority of the payload may be associated with a lower or higher modulation order or coding rate.

In further examples, the L1-RSRPs/SINRs associated with the secondary CMR-IDs may be reported in a different CSI report (e.g., second CSI report) from an initial/first CSI report that includes the primary CMR-IDs and the associated primary L1-RSRPs/L1-SINRs. The second CSI report may include an identifier that the second CSI report includes the second L1-RSRPs/SINRs of the secondary CMR-IDs. The second CSI report may be explicitly linked to the first CSI report that includes the primary CMR-IDs and the associated primary L1-RSRPs/SINRs based on including a second CSI report identifier within the first CSI report.

Techniques for determining the secondary CMR-IDs may include determining which particular CMR-IDs may be identified as secondary CMR-IDs based on a determined primary CMR-ID. The secondary CMR-IDs may also be determined by the UE based 1 on standard/pre-defined protocols or base station pre-configurations/indications. In a first example, the adjacency of the secondary CMR-IDs may be determined based on beam direction information associated with CMRs that are separately configured/indicated by the base station. In a second example, the adjacency of the secondary CMR-IDs may be determined based on CMR-ID indices. In a third example, the adjacency of the secondary CMR-IDs may be determined based on an explicit configuration/indication of the adjacent/neighboring (e.g., secondary) CMR-IDs based on a particular primary CMR-ID.

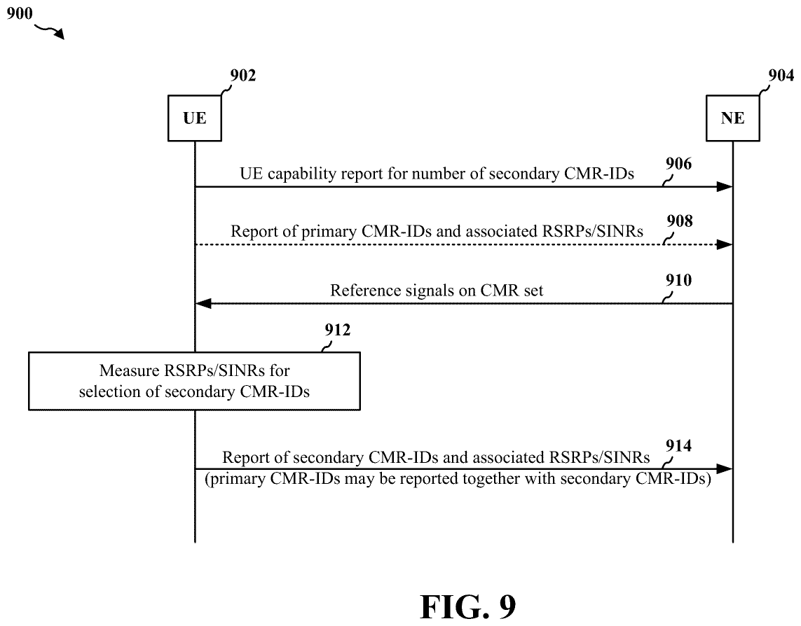

FIG. 9 is a call flow diagram 900 illustrating communications between a UE 902 and a network entity 904. The network entity 904 may correspond to a base station or an entity at a base station, such as a CU, a DU, an RU, etc. The network entity 904 may correspond to a TRP and the communications between the UE 902 and the TRP may be communicated with mTRPs.

At 906, the UE 902 may transmit a UE capability report to the network entity 904 for a number of secondary CMR-IDs for which the UE 902 may measure RSRPs/SINRs associated with the secondary CMR-IDs. “RSRPs/SINRs” may refer to a signal quality associated with the CMRs. The RSRPs/SINRs may be either L1-RSRPs/SINRs or L3-RSRPs/SINRs. The report transmitted, at 906, to the network entity 904 may indicate a total number of secondary CMR-IDs for which the UE 902 may measure RSRPs/SINRs within a particular CMR set and/or a total number of secondary CMR-IDs for which the UE 902 may measure RSRPs/SINRs within a plurality of CMR sets. At 908, the UE 902 may transmit a report of primary CMR-IDs and associated RSRPs/SINRs to the network entity 904 based on configured/activated/triggered periodic, semi-persistent, or aperiodic L1-RSRP/SINR reporting procedures.

At 910, the network entity 904 may transmit reference signals to the UE 902 on a CMR for measuring the RSRPs/SINRs of the CMRs included in the CMR set. The reference signals transmitted, at 910, from the network entity 904 to the UE 902 may be based on the UE capability report received, at 906, by the network entity 904 and/or the report of the primary CMR-IDs and associated RSRPs/SINRs received, at 908, by the network entity 904. The CMR set may include one or more primary CMRs associated with one or more primary CMR-IDs as well as one or more secondary CMRs associated with one or more secondary CMR-IDs.

At 912, the UE 902 may measure the RSRPs/SINRs for selection of the secondary CMR-IDs, where the secondary CMR-IDs are different from the primary CMR-IDs. After the secondary CMR-IDs are selected by the UE 902 from the CMR set, the UE 902 may transmit, at 914, a report of the secondary CMR-IDs and associated RSRPs/SINRs to the network entity 904. In examples, rather than reporting the primary CMR-IDs and associated RSRPs/SINRs, at 908, to the network entity 904, the primary CMR-IDs and associated RSRPs/SINRs may be reported, at 914, to the network entity 904 together with the secondary CMR-IDs and associated RSRPs/SINRs.

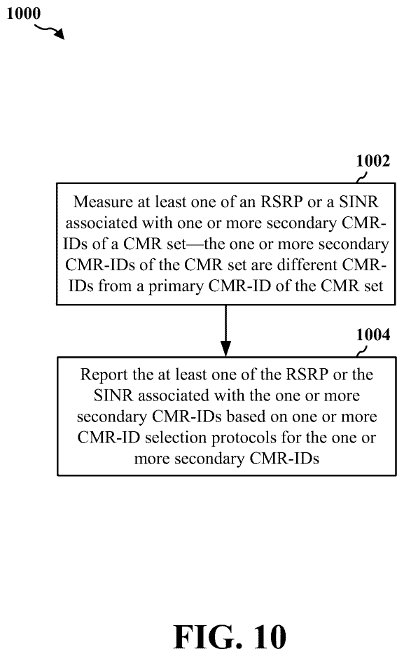

FIG. 10 is a flowchart 1000 of a method of wireless communication. The method may be performed by a UE (e.g., the UE 104, 350, 902, the apparatus 1404, etc.), which may include the memory 360 and which may correspond to the entire UE 104, 350, 902 or apparatus 1404, or a component of the UE 104, 350, 902 or the apparatus 1404, such as the TX processor 368, the RX processor 356, the controller/processor 359, the cellular baseband processor 1424, and/or the application processor 1406.

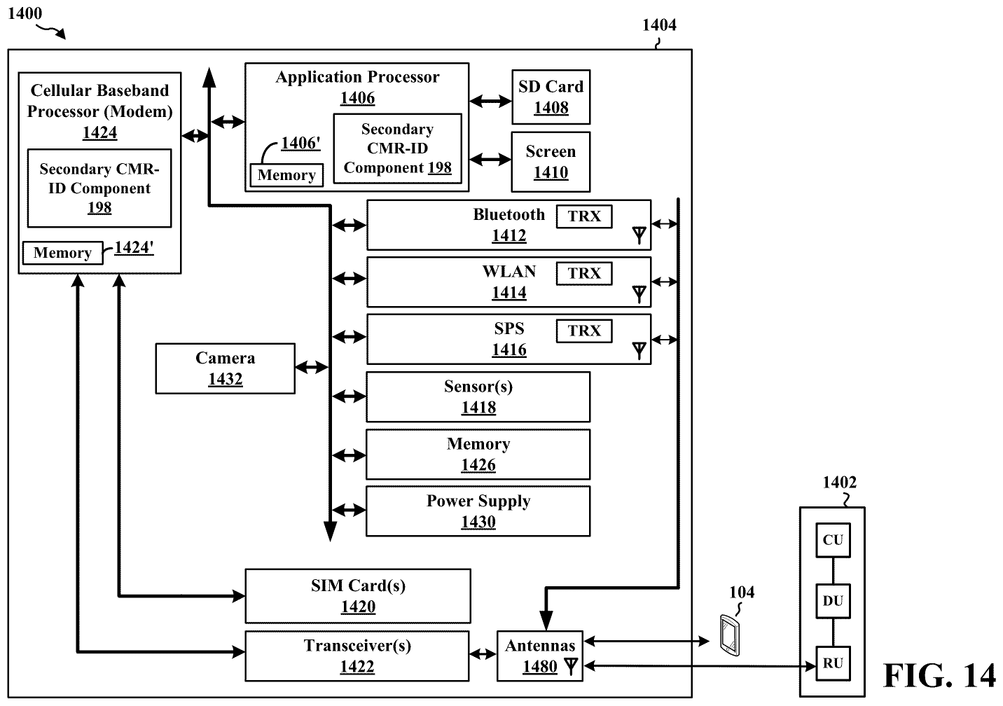

At 1002, the UE may measure at least one of an RSRP or a SINR associated with one or more secondary CMR-IDs of a CMR set—the one or more secondary CMR-IDs of the CMR set are different CMR-IDs from a primary CMR-ID of the CMR set. For example, referring to FIGS. 7 and 9, the UE 902 may measure, at 912, RSRPs/SINRs for selection of the secondary CMR-IDs. The diagram 700 illustrates that the secondary CMR-IDs 704a-704b are different from the primary CMR-IDs 702a-702b. The measurement, at 1002, may be performed by the secondary CMR-ID component 198 of the apparatus 1404 in FIG. 14.

At 1004, the UE may report the at least one of the RSRP or the SINR associated with the one or more secondary CMR-IDs based on one or more CMR-ID selection protocols for the one or more secondary CMR-IDs. CMR-ID selection protocols refers to procedures for selecting the one or more secondary CMR-IDs, such as illustrated via 714, 716, and 718 of the diagram 700. Referring to FIGS. 7 and 9, the UE 902 may transmit, at 914, a report of the secondary CMR-IDs and associated RSRPs/SINRs to the network entity 904 after selection of the secondary CMR-IDs based on the measurement, at 912, of the RSRPs/SINRs associated with the secondary CMR-IDs. In the diagram 700, the adjacency procedures, at 708, for a particular CMR may, at 712, be based on L1-RSRP/SINR reporting techniques. The reporting, at 1004, may be performed by the secondary CMR-ID component 198 of the apparatus 1404 in FIG. 14.

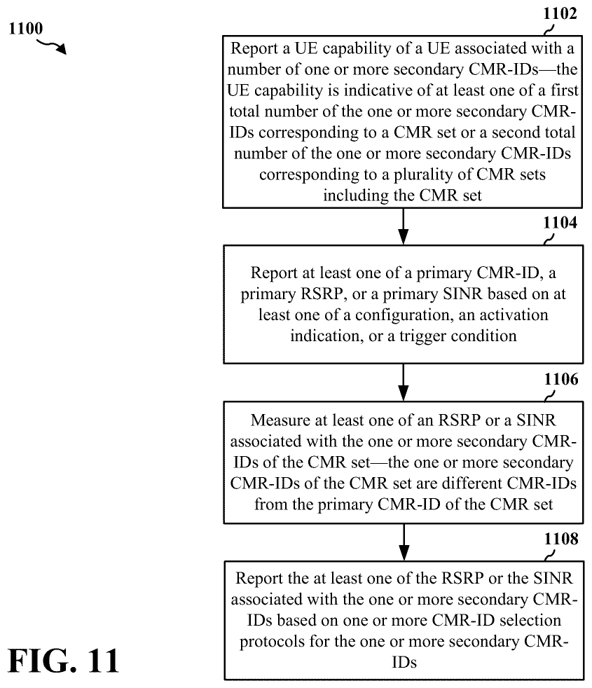

FIG. 11 is a flowchart 1100 of a method of wireless communication. The method may be performed by a UE (e.g., the UE 104, 350, 902, the apparatus 1404, etc.), which may include the memory 360 and which may correspond to the entire UE 104, 350, 902 or apparatus 1404, or a component of the UE 104, 350, 902 or the apparatus 1404, such as the TX processor 368, the RX processor 356, the controller/processor 359, the cellular baseband processor 1424, and/or the application processor 1406.

At 1102, the UE may report a UE capability of a UE associated with a number of one or more secondary CMR-IDs—the UE capability is indicative of at least one of a first total number of the one or more secondary CMR-IDs corresponding to a CMR set or a second total number of the one or more secondary CMR-IDs corresponding to a plurality of CMR sets including the CMR set. For example, referring to FIGS. 7 and 9, the UE 902 may transmit, at 906, a UE capability report to the network entity 904 for a number of secondary CMR-IDs. In the diagram 700, the adjacency procedures, at 708, for a particular CMR may, at 710, be based on a number of secondary CMR-IDs per primary CMR-ID. The reporting, at 1102, may be performed by the secondary CMR-ID component 198 of the apparatus 1404 in FIG. 14.

At 1104, the UE may report at least one of a primary CMR-ID, a primary RSRP, or a primary SINR based on at least one of a configuration, an activation indication, or a trigger condition. The configuration may correspond to a periodic CSI report, the activation indication may correspond to a semi-persistent CSI report, and the trigger condition may correspond to an aperiodic CSI report. For example, referring to FIGS. 7 and 9, the UE 902 may transmit, at 908, a report of primary CMR-IDs and associated RSRPs/SINRs to the network entity 904. The primary CMR-IDs may also be transmitted, at 914, to the network entity 904 together with the secondary CMR-IDs. At 706, CMR-ID reporting may be RRC configured, MAC-CE activated/updated, or DCI triggered/changed. The reporting, at 1104, may be performed by the secondary CMR-ID component 198 of the apparatus 1404 in FIG. 14.

At 1106, the UE may measure at least one of an RSRP or a SINR associated with the one or more secondary CMR-IDs of the CMR set—the one or more secondary CMR-IDs of the CMR set are different CMR-IDs from the primary CMR-ID of the CMR set. For example, referring to FIGS. 7 and 9, the UE 902 may measure, at 912, RSRPs/SINRs for selection of the secondary CMR-IDs. The diagram 700 illustrates that the secondary CMR-IDs 704a-704b are different from the primary CMR-IDs 702a-702b. The measurement, at 1106, may be performed by the secondary CMR-ID component 198 of the apparatus 1404 in FIG. 14.

At 1108, the UE may report the at least one of the RSRP or the SINR associated with the one or more secondary CMR-IDs based on one or more CMR-ID selection protocols for the one or more secondary CMR-IDs. For example, referring to FIGS. 7 and 9, the UE 902 may transmit, at 914, a report of the secondary CMR-IDs and associated RSRPs/SINRs to the network entity 904 after selection of the secondary CMR-IDs based on the measurement, at 912, of the RSRPs/SINRs associated with the secondary CMR-IDs. In the diagram 700, the adjacency procedures, at 708, for a particular CMR may, at 712, be based on L1-RSRP/SINR reporting techniques. The reporting, at 1108, may be performed by the secondary CMR-ID component 198 of the apparatus 1404 in FIG. 14.

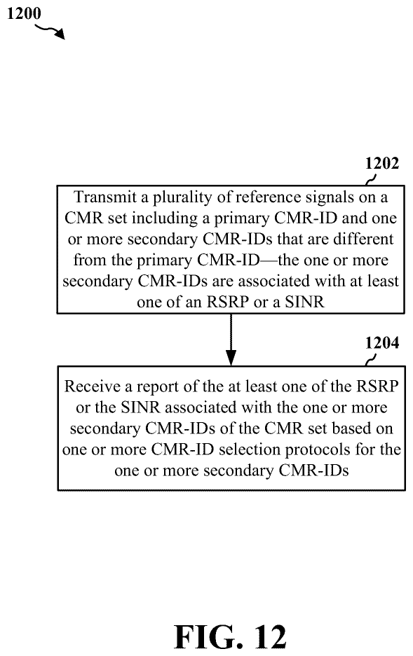

FIG. 12 is a flowchart 1200 of a method of wireless communication. The method may be performed by a network entity or a base station (e.g., the network entity 904, 1402, 1502, the base station 102, 310, the CU 110/1510, the DU 130/1530, the RU 140/1540, etc.), which may include the memory 376 and which may correspond to the entire network entity 904, 1402, 1502 or base station 102, 310, or a component of the network entity 904, 1402, 1502 or the base station 102, 310, such as the CU 110/1510, the DU 130/1530, the RU 140/1540, the TX processor 316, the RX processor 370, and/or the controller/processor 375.

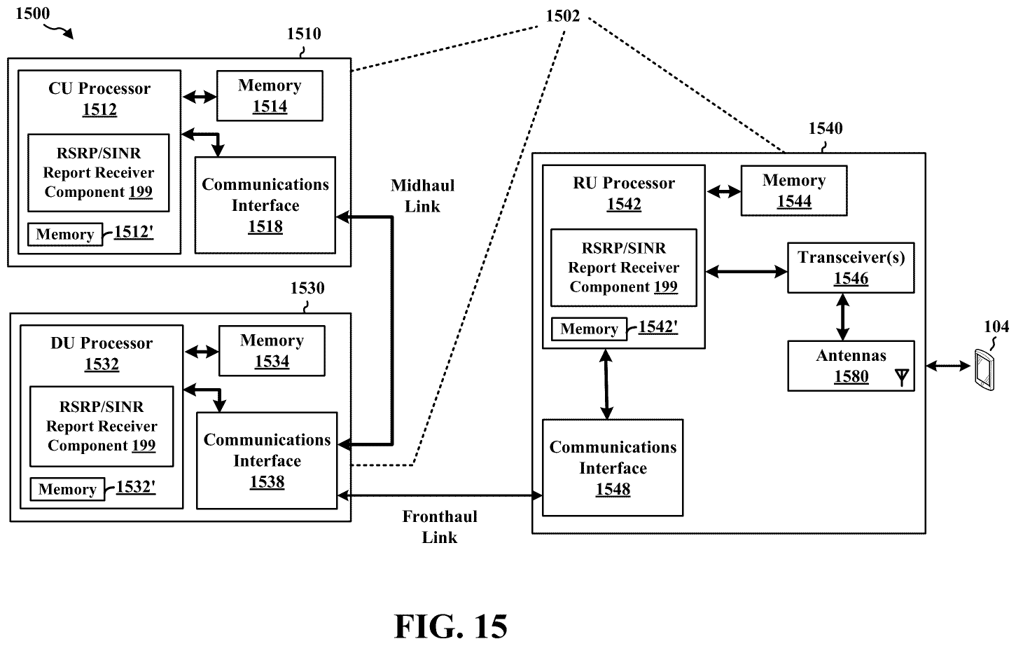

At 1202, the network entity or the base station may transmit a plurality of reference signals on a CMR set including a primary CMR-ID and one or more secondary CMR-IDs that are different from the primary CMR-ID—the one or more secondary CMR-IDs are associated with at least one of an RSRP or a SINR. For example, referring to FIGS. 7 and 9, the network entity 904 may transmit, at 910, reference signals on a CMR set to the UE 902 for measurement, at 912, of the RSRPs/SINRs of the secondary CMR-IDs. The diagram 700 illustrates that the secondary CMR-IDs 704a-704b are different from the primary CMR-IDs 702a-702b. The transmission, at 1202, may be performed by the RSRP/SINR report receiver component 199 of the network entity 1502 in FIG. 15.

At 1204, the network entity or the base station may receive a report of the at least one of the RSRP or the SINR associated with the one or more secondary CMR-IDs of the CMR set based on one or more CMR-ID selection protocols for the one or more secondary CMR-IDs. For example, referring to FIGS. 7 and 9, the network entity 904 may receive, at 914, a report of the secondary CMR-IDs and associated RSRPs/SINRs from the UE 902 after selection of the secondary CMR-IDs based on the measurement, at 912, of the RSRPs/SINRs associated with the secondary CMR-IDs. In the diagram 700, the adjacency procedures, at 708, for a particular CMR may, at 712, be based on L1-RSRP/SINR reporting techniques. The reception, at 1204, may be performed by the RSRP/SINR report receiver component 199 of the network entity 1502 in FIG. 15.

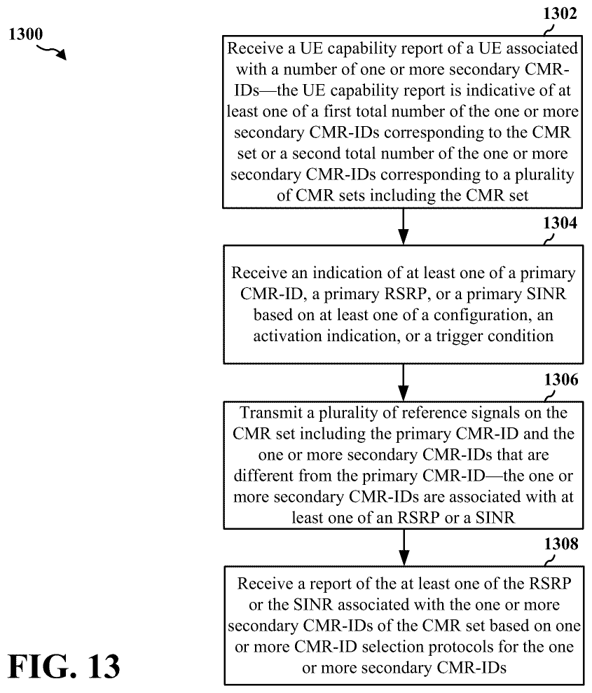

FIG. 13 is a flowchart 1300 of a method of wireless communication. The method may be performed by a network entity or a base station (e.g., the network entity 904, 1402, 1502, the base station 102, 310, the CU 110/1510, the DU 130/1530, the RU 140/1540, etc.), which may include the memory 376 and which may correspond to the entire network entity 904, 1402, 1502 or base station 102, 310, or a component of the network entity 904, 1402, 1502 or the base station 102, 310, such as the CU 110/1510, the DU 130/1530, the RU 140/1540, the TX processor 316, the RX processor 370, and/or the controller/processor 375.

At 1302, the network entity or the base station may receive a UE capability report of a UE associated with a number of one or more secondary CMR-IDs—the UE capability report is indicative of at least one of a first total number of the one or more secondary CMR-IDs corresponding to the CMR set or a second total number of the one or more secondary CMR-IDs corresponding to a plurality of CMR sets including the CMR set. For example, referring to FIGS. 7 and 9, the network entity 904 may receive, at 906, a UE capability report from the UE 902 for a number of secondary CMR-IDs. In the diagram 700, the adjacency procedures, at 708, for a particular CMR may, at 710, be based on a number of secondary CMR-IDs per primary CMR-ID. The reception, at 1302, may be performed by the RSRP/SINR report receiver component 199 of the network entity 1502 in FIG. 15.

At 1304, the network entity or the base station may receive an indication of at least one of a primary CMR-ID, a primary RSRP, or a primary SINR based on at least one of a configuration, an activation indication, or a trigger condition. For example, referring to FIGS. 7 and 9, the network entity 904 may receive, at 908, a report of primary CMR-IDs and associated RSRPs/SINRs from the UE 902. The primary CMR-IDs may also be received, at 914, from the UE 902 together with the secondary CMR-IDs. At 706, CMR-ID reporting may be RRC configured, MAC-CE activated/updated, or DCI triggered/changed. The reception, at 1304, may be performed by the RSRP/SINR report receiver component 199 of the network entity 1502 in FIG. 15.

At 1306, the network entity or the base station may transmit a plurality of reference signals on the CMR set including the primary CMR-ID and the one or more secondary CMR-IDs that are different from the primary CMR-ID—the one or more secondary CMR-IDs are associated with at least one of an RSRP or a SINR. For example, referring to FIGS. 7 and 9, the network entity 904 may transmit, at 910, reference signals on a CMR set to the UE 902 for measurement, at 912, of the RSRPs/SINRs of the secondary CMR-IDs. The diagram 700 illustrates that the secondary CMR-IDs 704a-704b are different from the primary CMR-IDs 702a-702b. The transmission, at 1306, may be performed by the RSRP/SINR report receiver component 199 of the network entity 1502 in FIG. 15.

At 1308, the network entity or the base station may receive a report of the at least one of the RSRP or the SINR associated with the one or more secondary CMR-IDs of the CMR set based on one or more CMR-ID selection protocols for the one or more secondary CMR-IDs. For example, referring to FIGS. 7 and 9, the network entity 904 may receive, at 914, a report of the secondary CMR-IDs and associated RSRPs/SINRs from the UE 902 after selection of the secondary CMR-IDs based on the measurement, at 912, of the RSRPs/SINRs associated with the secondary CMR-IDs. In the diagram 700, the adjacency procedures, at 708, for a particular CMR may, at 712, be based on L1-RSRP/SINR reporting techniques. The reception, at 1308, may be performed by the RSRP/SINR report receiver component 199 of the network entity 1502 in FIG. 15.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional modules of memory 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional modules of memory 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see 350 of FIG. 3) and include the additional modules of the apparatus 1404.

As discussed supra, the secondary CMR-ID component 198 is configured to measure at least one of an RSRP or a SINR associated with one or more secondary CMR-IDs of a CMR set, the one or more secondary CMR-IDs of the CMR set being different CMR-IDs from a primary CMR-ID of the CMR set; and report the at least one of the RSRP or the SINR associated with the one or more secondary CMR-IDs based on one or more CMR-ID selection protocols for the one or more secondary CMR-IDs. The secondary CMR-ID component 198 may be within the cellular baseband processor 1424, the application processor 1406, or both the cellular baseband processor 1424 and the application processor 1406. The secondary CMR-ID component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1404 may include a variety of components configured for various functions. In one configuration, the apparatus 1404, and in particular the cellular baseband processor 1424 and/or the application processor 1406, includes means for measuring at least one of an RSRP or a SINR associated with one or more secondary CMR-IDs of a CMR set, the one or more secondary CMR-IDs of the CMR set being different CMR-IDs from a primary CMR-ID of the CMR set; and means for reporting the at least one of the RSRP or the SINR associated with the one or more secondary CMR-IDs based on one or more CMR-ID selection protocols for the one or more secondary CMR-IDs. The apparatus 1404 further includes means for reporting the at least one of the primary CMR-ID, the primary RSRP, or the primary SINR based on at least one of a configuration, an activation indication, or a trigger condition. The apparatus 1404 further includes means for reporting a UE capability of the UE associated with a number of the one or more secondary CMR-IDs, where the UE capability is indicative of at least one of a first total number of the one or more secondary CMR-IDs corresponding to the CMR set or a second total number of the one or more secondary CMR-IDs corresponding to a plurality of CMR sets including the CMR set.

The means may be the secondary CMR-ID component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the RSRP/SINR report receiver component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the RSRP/SINR report receiver component 199 is configured to transmit a plurality of reference signals on a CMR set including a primary CMR-ID and one or more secondary CMR-IDs that are different from the primary CMR-ID, the one or more secondary CMR-IDs associated with at least one of an RSRP or a SINR; and receive a report of the at least one of the RSRP or the SINR associated with the one or more secondary CMR-IDs of the CMR set based on one or more CMR-ID selection protocols for the one or more secondary CMR-IDs. The RSRP/SINR report receiver component 199 may be within one or more processors of one or more of the CU 1510, DU 1530, and the RU 1540. The RSRP/SINR report receiver component 199 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 1502 may include a variety of components configured for various functions. In one configuration, the network entity 1502 includes means for transmitting a plurality of reference signals on a CMR set including a primary CMR-ID and one or more secondary CMR-IDs that are different from the primary CMR-ID, the one or more secondary CMR-IDs associated with at least one of an RSRP or a SINR; and means for receiving a report of the at least one of the RSRP or the SINR associated with the one or more secondary CMR-IDs of the CMR set based on one or more CMR-ID selection protocols for the one or more secondary CMR-IDs. The network entity 1502 further includes means for receiving an indication of the at least one of the primary CMR-ID, the primary RSRP, or the primary SINR based on at least one of a configuration, an activation indication, or a trigger condition. The network entity 1502 further includes means for receiving a UE capability report of the UE associated with a number of the one or more secondary CMR-IDs, where the UE capability report is indicative of at least one of a first total number of the one or more secondary CMR-IDs corresponding to the CMR set or a second total number of the one or more secondary CMR-IDs corresponding to a plurality of CMR sets including the CMR set.

The means may be the RSRP/SINR report receiver component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: measuring at least one of an RSRP or a SINR associated with one or more secondary CMR-IDs of a CMR set, the one or more secondary CMR-IDs of the CMR set being different CMR-IDs from a primary CMR-ID of the CMR set; and reporting the at least one of the RSRP or the SINR associated with the one or more secondary CMR-IDs based on one or more CMR-ID selection protocols for the one or more secondary CMR-IDs.

Aspect 2 may be combined with aspect 1 and includes that the one or more CMR-ID selection protocols for the one or more secondary CMR-IDs are based on at least one of the primary CMR-ID, a primary RSRP associated with the primary CMR-ID, or a primary SINR associated with the primary CMR-ID.

Aspect 3 may be combined with any of aspects 1-2 and further includes reporting the at least one of the primary CMR-ID, the primary RSRP, or the primary SINR based on at least one of a configuration, an activation indication, or a trigger condition.

Aspect 4 may be combined with any of aspects 1-3 and includes that the CMR set is included in a plurality of CMR sets associated with mTRPs.

Aspect 5 may be combined with any of aspects 1-4 and includes that the CMR set includes at least one of a CSI-RS resource or an SSB resource associated with at least one of a periodic report, a semi-persistent report, or an aperiodic report for the at least one of the RSRP or the SINR associated with the one or more secondary CMR-IDs.

Aspect 6 may be combined with any of aspects 1-5 and includes that the one or more CMR-ID selection protocols are based on at least one of a predefined rule, an RRC configuration, a MAC-CE, or DCI for different CMR sets.

Aspect 7 may be combined with any of aspects 1-6 and includes that a number of the one or more secondary CMR-IDs is based on at least one of a total number of CMR-IDs included in the CMR set, whether the CMR set includes a strongest primary CMR-ID of a plurality of primary CMR-IDs associated with a plurality of CMR sets that includes the CMR set, or a QCL relationship between a CMR of the CMR set and a CORESET associated with the CMR set.

Aspect 8 may be combined with any of aspects 1-7 and further includes reporting a UE capability of the UE associated with a number of the one or more secondary CMR-IDs, where the UE capability is indicative of at least one of a first total number of the one or more secondary CMR-IDs corresponding to the CMR set or a second total number of the one or more secondary CMR-IDs corresponding to a plurality of CMR sets including the CMR set.

Aspect 9 may be combined with any of aspects 1-8 and includes that the at least one of the RSRP or the SINR associated with the one or more secondary CMR-IDs is reported based on one or more bits that indicate a particular primary CMR-ID of a plurality of primary CMR-IDs.

Aspect 10 may be combined with any of aspects 1-9 and includes that the at least one of the RSRP or the SINR associated with the one or more secondary CMR-IDs is reported based on one or more bits that indicate the primary CMR-ID of the CMR set associated with the one or more secondary CMR-IDs.

Aspect 11 may be combined with any of aspects 1-10 and includes that the at least one of the RSRP or the SINR associated with the one or more secondary CMR-IDs is reported based on a bit size associated with a number of the one or more secondary CMR-IDs.

Aspect 12 may be combined with any of aspects 1-11 and includes that the at least one of the RSRP or the SINR associated with the one or more secondary CMR-IDs is reported in a same report as at least one of the primary CMR-ID, a primary RSRP associated with the primary CMR-ID, or a primary SINR associated with the primary CMR-ID.

Aspect 13 may be combined with any of aspects 1-11 and includes that the at least one of the RSRP or the SINR associated with the one or more secondary CMR-IDs is reported in a different report from the primary CMR-ID, a primary RSRP associated with the primary CMR-ID, and a primary SINR associated with the primary CMR-ID.

Aspect 14 is a method of wireless communication at a network node, including: transmitting a plurality of reference signals on a CMR set including a primary CMR-ID and one or more secondary CMR-IDs that are different from the primary CMR-ID, the one or more secondary CMR-IDs associated with at least one of an RSRP or a SINR; and receiving a report of the at least one of the RSRP or the SINR associated with the one or more secondary CMR-IDs of the CMR set based on one or more CMR-ID selection protocols for the one or more secondary CMR-IDs.

Aspect 15 may be combined with aspect 14 and includes that the one or more CMR-ID selection protocols for the one or more secondary CMR-IDs are based on at least one of the primary CMR-ID, a primary RSRP associated with the primary CMR-ID, or a primary SINR associated with the primary CMR-ID.

Aspect 16 may be combined with any of aspects 14-15 and further includes receiving an indication of the at least one of the primary CMR-ID, the primary RSRP, or the primary SINR based on at least one of a configuration, an activation indication, or a trigger condition.

Aspect 17 may be combined with any of aspects 14-16 and includes that the CMR set is included in a plurality of CMR sets associated with mTRPs.

Aspect 18 may be combined with any of aspects 14-17 and includes that the CMR set includes at least one of a CSI-RS resource or an SSB resource associated with at least one of a periodic report, a semi-persistent report, or an aperiodic report for the at least one of the RSRP or the SINR associated with the one or more secondary CMR-IDs.

Aspect 19 may be combined with any of aspects 14-18 and includes that the one or more CMR-ID selection protocols are based on at least one of a predefined rule, an RRC configuration, a MAC-CE, or DCI.

Aspect 20 may be combined with any of aspects 14-19 and includes that a number of the one or more secondary CMR-IDs is based on at least one of a total number of CMR-IDs included in the CMR set, whether the CMR set includes a strongest primary CMR-ID of a plurality of primary CMR-IDs associated with a plurality of CMR sets that includes the CMR set, or a QCL relationship between a CMR of the CMR set and a CORESET associated with the CMR set.

Aspect 21 may be combined with any of aspects 14-20 and further includes receiving a UE capability report of the UE associated with a number of the one or more secondary CMR-IDs, where the UE capability report is indicative of at least one of a first total number of the one or more secondary CMR-IDs corresponding to the CMR set or a second total number of the one or more secondary CMR-IDs corresponding to a plurality of CMR sets including the CMR set.

Aspect 22 may be combined with any of aspects 14-21 and includes that the report of the at least one of the RSRP or the SINR associated with the one or more secondary CMR-IDs is based on one or more bits that indicate a particular primary CMR-ID of a plurality of primary CMR-IDs.

Aspect 23 may be combined with any of aspects 14-22 and includes that the report of the at least one of the RSRP or the SINR associated with the one or more secondary CMR-IDs is based on one or more bits that indicate the primary CMR-ID of the CMR set associated with the one or more secondary CMR-IDs.

Aspect 24 may be combined with any of aspects 14-23 and includes that the report of the at least one of the RSRP or the SINR associated with the one or more secondary CMR-IDs is based on a bit size associated with a number of the one or more secondary CMR-IDs.

Aspect 25 may be combined with any of aspects 14-24 and includes that the report of the at least one of the RSRP or the SINR associated with the one or more secondary CMR-IDs is a same report as at least one of the primary CMR-ID, a primary RSRP associated with the primary CMR-ID, or a primary SINR associated with the primary CMR-ID.

Aspect 26 may be combined with any of aspects 14-24 and includes that the report of the at least one of the RSRP or the SINR associated with the one or more secondary CMR-IDs is a different report from the primary CMR-ID, a primary RSRP associated with the primary CMR-ID, and a primary SINR associated with the primary CMR-ID.

Aspect 27 is an apparatus for wireless communication for implementing a method as in any of aspects 1-26.

Aspect 28 is an apparatus for wireless communication including means for implementing a method as in any of aspects 1-26.

Aspect 29 may be combined with any of aspects 27-28 and further includes at least one of a transceiver or an antenna coupled to at least one processor of the apparatus.

Aspect 30 is a non-transitory computer-readable medium storing computer executable code, the code when executed by at least one processor causes the at least one processor to implement a method as in any of aspects 1-26.

What is claimed is:

1. An apparatus for wireless communication at a user equipment (UE), comprising:
a memory; and
at least one processor coupled to the memory and, based at least in part on information stored in the memory, the at least one processor is configured to:
measure, for a plurality of channel measurement resource (CMR) sets, at least one of a reference signal received power (RSRP) or a signal-to-interference-plus-noise ratio (SINR) associated with one or more secondary CMR identifiers (IDs) (CMR-IDs) of respective CMR sets included in the plurality of CMR sets, the one or more secondary CMR-IDs being different CMR-IDs from a primary CMR-ID of the respective CMR sets; and
report, for the plurality of CMR sets, the at least one of the RSRP or the SINR associated with the one or more secondary CMR-IDs based on one or more CMR-ID selection protocols for the one or more secondary CMR-IDs of the respective CMR sets.

2. The apparatus of claim 1, wherein the one or more CMR-ID selection protocols for the one or more secondary CMR-IDs are based on at least one of the primary CMR-ID, a primary RSRP associated with the primary CMR-ID, or a primary SINR associated with the primary CMR-ID.

3. The apparatus of claim 2, wherein the at least one processor is further configured to report, for the plurality of CMR sets, the at least one of the primary CMR-ID, the primary RSRP, or the primary SINR based on at least one of a configuration, an activation indication, or a trigger condition.

4. The apparatus of claim 1, wherein the RSRP corresponds to a layer 1 (L1) RSRP or a layer 3 (L3) RSRP and the SINR corresponds to an L1 SINR or an L3 SINR.

5. The apparatus of claim 1, wherein the respective CMR sets include at least one of a channel state information-reference signal (CSI-RS) resource or a synchronization signal block (SSB) resource associated with at least one of a periodic report, a semi-persistent report, or an aperiodic report for the at least one of the RSRP or the SINR associated with the one or more secondary CMR-IDs.

6. The apparatus of claim 1, wherein the one or more CMR-ID selection protocols are based on at least one of a predefined rule, a radio resource control (RRC) configuration, a medium access control (MAC) control element (CE) (MAC-CE), or downlink control information (DCI) that is different for different CMR sets of the plurality of CMR sets.

7. The apparatus of claim 1, wherein a number of the one or more secondary CMR-IDs of the respective CMR sets per primary CMR-ID of the respective CMR sets is based on at least one of a total number of CMR-IDs included in the respective CMR sets, whether a CMR set of the plurality of CMR sets includes a strongest primary CMR-ID of a plurality of primary CMR-IDs associated with the plurality of CMR sets, or a quasi co-location (QCL) relationship between a CMR of the CMR set and a control resource set (CORESET) associated with the CMR set.

8. The apparatus of claim 1, wherein the at least one processor is further configured to report a UE capability of the UE associated with a number of the one or more secondary CMR-IDs, wherein the UE capability is indicative of at least one of a first total number of the one or more secondary CMR-IDs corresponding to a CMR set of the plurality of CMR sets or a second total number of the one or more secondary CMR-IDs corresponding to the plurality of CMR sets including the CMR set.

9. The apparatus of claim 1, wherein the at least one of the RSRP or the SINR associated with the one or more secondary CMR-IDs is reported based on one or more bits that indicate a particular primary CMR-ID of a plurality of primary CMR-IDs included in the plurality of CMR sets.

10. The apparatus of claim 1, wherein the at least one of the RSRP or the SINR associated with the one or more secondary CMR-IDs is reported based on one or more bits that indicate the primary CMR-ID associated with the one or more secondary CMR-IDs.

11. The apparatus of claim 1, wherein the at least one of the RSRP or the SINR associated with the one or more secondary CMR-IDs is reported based on a bit size associated with a number of the one or more secondary CMR-IDs.

12. The apparatus of claim 1, wherein the at least one of the RSRP or the SINR associated with the one or more secondary CMR-IDs is reported in a same report as at least one of the primary CMR-ID, a primary RSRP associated with the primary CMR-ID, or a primary SINR associated with the primary CMR-ID.

13. The apparatus of claim 1, wherein the at least one of the RSRP or the SINR associated with the one or more secondary CMR-IDs is reported in a different report from the primary CMR-ID, a primary RSRP associated with the primary CMR-ID, and a primary SINR associated with the primary CMR-ID.

14. The apparatus of claim 1, further comprising at least one of a transceiver or an antenna coupled to the at least one processor.

15. An apparatus for wireless communication at a network node, comprising:
a memory; and
at least one processor coupled to the memory and, based at least in part on information stored in the memory, the at least one processor is configured to:
transmit a plurality of reference signals on a channel measurement resource (CMR) set including a primary CMR identifier (CMR-ID) and one or more secondary CMR-IDs that are different from the primary CMR-ID, the one or more secondary CMR-IDs associated with at least one of a reference signal received power (RSRP) or a signal-to-interference-plus-noise ratio (SINR); and
receive a report associated with a plurality of CMR sets including the CMR set, the report indicative of the at least one of the RSRP or the SINR associated with the one or more secondary CMR-IDs and based on one or more CMR-ID selection protocols for the one or more secondary CMR-IDs of the CMR set included in the plurality of CMR sets.

16. The apparatus of claim 15, wherein the one or more CMR-ID selection protocols for the one or more secondary CMR-IDs are based on at least one of the primary CMR-ID, a primary RSRP associated with the primary CMR-ID, or a primary SINR associated with the primary CMR-ID.

17. The apparatus of claim 16, wherein the at least one processor is further configured to receive an indication of the at least one of the primary CMR-ID, the primary RSRP, or the primary SINR based on at least one of a configuration, an activation indication, or a trigger condition.

18. The apparatus of claim 15, wherein the RSRP corresponds to a layer 1 (L1) RSRP or a layer 3 (L3) RSRP and the SINR corresponds to an L1 SINR or an L3 SINR.

19. The apparatus of claim 15, wherein the CMR set includes at least one of a channel state information-reference signal (CSI-RS) resource or a synchronization signal block (SSB) resource associated with at least one of a periodic report, a semi-persistent report, or an aperiodic report for the at least one of the RSRP or the SINR associated with the one or more secondary CMR-IDs.

20. The apparatus of claim 15, wherein the one or more CMR-ID selection protocols are based on at least one of a predefined rule, a radio resource control (RRC) configuration, a medium access control (MAC) control element (CE) (MAC-CE), or downlink control information (DCI) that is different from a second CMR set included in the plurality of CMR sets.

21. The apparatus of claim 15, wherein a number of the one or more secondary CMR-IDs of the CMR set per primary CMR-ID of the CMR set is based on at least one of a total number of CMR-IDs included in the CMR set, whether the CMR set includes a strongest primary CMR-ID of a plurality of primary CMR-IDs associated with the plurality of CMR sets, or a quasi co-location (QCL) relationship between a CMR of the CMR set and a control resource set (CORESET) associated with the CMR set.

22. The apparatus of claim 15, wherein the at least one processor is further configured to receive a UE capability report of the UE associated with a number of the one or more secondary CMR-IDs, wherein the UE capability report is indicative of at least one of a first total number of the one or more secondary CMR-IDs corresponding to the CMR set of the plurality of CMR sets or a second total number of the one or more secondary CMR-IDs corresponding to the plurality of CMR sets including the CMR set.

23. The apparatus of claim 15, wherein the report of the at least one of the RSRP or the SINR associated with the one or more secondary CMR-IDs is based on one or more bits that indicate a particular primary CMR-ID of a plurality of primary CMR-IDs included in the plurality of CMR sets.

24. The apparatus of claim 15, wherein the report of the at least one of the RSRP or the SINR associated with the one or more secondary CMR-IDs is based on one or more bits that indicate the primary CMR-ID of the CMR set associated with the one or more secondary CMR-IDs.

25. The apparatus of claim 15, wherein the report of the at least one of the RSRP or the SINR associated with the one or more secondary CMR-IDs is based on a bit size associated with a number of the one or more secondary CMR-IDs.

26. The apparatus of claim 15, wherein the report of the at least one of the RSRP or the SINR associated with the one or more secondary CMR-IDs is a same report as at least one of the primary CMR-ID, a primary RSRP associated with the primary CMR-ID, or a primary SINR associated with the primary CMR-ID.

27. The apparatus of claim 15, wherein the report of the at least one of the RSRP or the SINR associated with the one or more secondary CMR-IDs is a different report from the primary CMR-ID, a primary RSRP associated with the primary CMR-ID, and a primary SINR associated with the primary CMR-ID.

28. The apparatus of claim 15, further comprising at least one of a transceiver or an antenna coupled to the at least one processor.

29. A method of wireless communication at a user equipment (UE), comprising:
measuring, for a plurality of channel measurement resource (CMR) sets, at least one of a reference signal received power (RSRP) or a signal-to-interference-plus-noise ratio (SINR) associated with one or more secondary CMR identifiers (IDs) (CMR-IDs) of respective CMR sets included in the plurality of CMR sets, the one or more secondary CMR-IDs being different CMR-IDs from a primary CMR-ID of the respective CMR sets; and
reporting, for the plurality of CMR sets, the at least one of the RSRP or the SINR associated with the one or more secondary CMR-IDs based on one or more CMR-ID selection protocols for the one or more secondary CMR-IDs of the respective CMR sets.

30. A method of wireless communication at a network node, comprising:
transmitting a plurality of reference signals on a channel measurement resource (CMR) set including a primary CMR identifier (CMR-ID) and one or more secondary CMR-IDs that are different from the primary CMR-ID, the one or more secondary CMR-IDs associated with at least one of a reference signal received power (RSRP) or a signal-to-interference-plus-noise ratio (SINR); and
receiving a report associated with a plurality of CMR sets including the CMR set, the report indicative of the at least one of the RSRP or the SINR associated with the one or more secondary CMR-IDs and based on one or more CMR-ID selection protocols for the one or more secondary CMR-IDs of the CMR set included in the plurality of CMR sets.
